(19) United States
(12) Patent Application Publication
(10) Pub. No.: US 2026/0173144 A1
(43) Pub. Date: Jun. 18, 2026

(54) TIMING ADVANCE (TA) ACQUISITION PROCEDURE BASED ON USER EQUIPMENT (UE) CAPABILITY IN WIRELESS NETWORKS

(71) Applicant: Rakuten Symphony, Inc., Tokyo (JP)

(72) Inventor: Subramanya CHANDRASHEKAR, Karnataka (IN)

(21) Appl. No.: 18/846,662

(22) PCT Filed: Jul. 8, 2024
(86) PCT No.: PCT/US2024/037042

§ 371 Date: Sep. 13, 2024

(30) Foreign Application Priority Data
Nov. 3, 2023 (IN) 202341075290
Jun. 4, 2024 (IN) 202341075290

(51) Int. Cl. H04W 74/0833; H04W 76/38

(52) U.S. Cl. CPC H04W 74/0833; H04W 76/38

(57) ABSTRACT

A method includes identifying a capability of a UE to perform Timing Advance (TA) measurement of Layer1/layer2 Triggered Mobility (LTM) candidate cells, based on UE capability information received from the UE. The UE capability information is transmitted to a serving Distributed Unit (DU), during configuration preparation of the LTM in the UE. The UE capability information is transmitted to a candidate/target DU associated with an LTM candidate/target cell selected from the LTM candidate cells. An acknowledgement is received from the serving DU and/or the candidate/target DU indicating non-allocation of Physical Random-Access Channel (PRACH) resources to the UE for performing Uplink (UL) synchronization to acquire TA of the LTM candidate/target cell.

### RELATED APPLICATIONS

This application claims priority to Indian Patent Application IN 2023-41075290, filed Nov. 3, 2023, the entire contents of which are hereby incorporated by reference.

### FIELD

The present disclosure relates to Timing Advance (TA) acquisition procedure based on User Equipment (UE) capability in wireless networks.

### BACKGROUND

Mobility management includes assigning, controlling, and managing devices, services, and infrastructure related to mobile communications. Mobile management is one of the core features in 3rd Generation Partnership Project (3GPP) technology for mobile communication networks which provides service continuity to moving User Equipment (UE). When a UE moves from a coverage area of one cell to another, a handover process is initiated in order to change a serving cell for the UE. A Lower-layer Triggered mobility (LTM) or L1/L2 based mobility was introduced in Release 18 of Third Generation Partnership Project (3GPP). LTM enables a serving cell change via L1/L2 signaling, while maintaining configuration of upper layers and/or minimizing changes of configuration of the lower layers. The LTM provides improvements in handover latency and interruption time compared to Layer 3 based mobility.

Timing advance (TA) is used to control uplink transmission timing of individual UE. TA helps to ensure that uplink transmissions from all UE are synchronized. The UE needs to perform TA acquisition to acquire the TA of a LTM candidate/target cell when there is a handover from a LTM serving cell to the LTM candidate/target cell.

In 3GPP, a disaggregated architecture of gNodeB (gNB) is defined as decomposing the gNB into multiple logical entities. The gNB is split into three logical nodes i.e., Centralised unit (CU), Distributed Unit (DU), and Radio Unit (RU). A single DU may host multiple cells. For instance, the 3GPP defines that a DU can host up to 512 cells. The CU (also referred as gNB-CU) hosts upper layers such as Packet Data Convergence Protocol (PDCP) and Radio Resource Control (RRC) layers, while the DU (also referred as gNB-DU) hosts lower layers such as Radio Link Control (RLC), Media Access Control (MAC), and Physical (PHY) layers. The scheduling operation takes place at the gNB-DU.

The information disclosed in this background section is only for enhancement of understanding of the general background of the disclosure and should not be taken as an acknowledgement or any form of suggestion that this information forms the prior art already known to a person skilled in the art.

### SUMMARY

In an embodiment, the present disclosure discloses a method. The method comprises identifying a capability of a UE to perform Timing Advance (TA) measurement of Layer1/layer2 Triggered Mobility (LTM) candidate cells, based on UE capability information received from the UE. Further, the method comprises transmitting the UE capability information to a serving Distributed Unit (DU), during configuration preparation of the LTM in the UE. Furthermore, the method comprises transmitting the UE capability information to a candidate/target DU associated with an LTM candidate/target cell selected from the LTM candidate cells. Thereafter, the method comprises receiving an acknowledgement from the serving DU and/or the candidate/target DU indicating non-allocation of Physical Random-Access Channel (PRACH) resources to the UE for performing Uplink (UL) synchronization to acquire TA of the LTM candidate/target cell.

In an embodiment, the present disclosure discloses a method. The method comprises receiving User Equipment (UE) capability information indicating a capability of a UE to perform Timing Advance (TA) measurement of LTM candidate cells, from a Centralized Unit (CU). The UE capability information is received during configuration preparation of the LTM in the UE. Further, the method comprises transmitting an acknowledgement to the CU indicating non-allocation of Physical Random-Access Channel (PRACH) resources for performing Uplink (UL) synchronization to acquire TA of an LTM candidate/target cell selected from the LTM candidate cells.

In an embodiment, the present disclosure discloses a Centralized Unit (CU). The CU is configured to identify a capability of a UE to perform Timing Advance (TA) measurement of Layer1/layer2 Triggered Mobility (LTM) candidate cells, based on UE capability information received from the UE. Further, the CU is configured to transmit the UE capability information to a serving Distributed Unit (DU), during configuration preparation of the LTM candidate cells in the UE. Furthermore, the CU is configured to transmit the UE capability information to a candidate/target DU associated with an LTM candidate/target cell selected from the LTM candidate cells. Thereafter, the CU is configured to receive an acknowledgement from the serving DU and/or the candidate/target DU indicating non-allocation of Physical Random-Access Channel (PRACH) resources to the UE for performing Uplink (UL) synchronization to acquire TA of the LTM candidate/target cell.

In an embodiment, the present disclosure discloses a serving Distributed Unit (DU). The serving DU is configured to receive User Equipment (UE) capability information indicating a capability of a UE to perform Timing Advance (TA) measurement of LTM candidate cells, from a Centralized Unit (CU). The UE capability information is received during configuration preparation of the LTM in the UE. Further, the serving DU is configured to transmit an acknowledgement to the CU indicating non-allocation of Physical Random-Access Channel (PRACH) resources for performing Uplink (UL) synchronization to acquire TA of an LTM candidate/target cell selected from the LTM candidate cells.

In an embodiment, the present disclosure discloses a non-transitory computer readable medium including instructions for performing operations. The operations comprise identifying a capability of a UE to perform Timing Advance (TA) measurement of Layer1/layer2 Triggered Mobility (LTM) candidate cells, based on UE capability information received from the UE. Further, the operations comprise transmitting the UE capability information to a serving Distributed Unit (DU), during configuration preparation of the LTM in the UE. Furthermore, the operations comprise transmitting the UE capability information to a candidate/target DU associated with an LTM candidate/target cell selected from the LTM candidate cells. Thereafter, the operations comprise receiving an acknowledgement from the serving DU and/or the candidate/target DU indicating non-allocation of Physical Random-Access Channel (PRACH) resources to the UE for performing Uplink (UL) synchronization to acquire TA of the LTM candidate/target cell.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1A illustrates a current disaggregated gNodeB (gNB) architecture;

FIG. 1B illustrates an exemplary environment for performing Timing Advance (TA) acquisition procedure based on User Equipment (UE) capability in wireless networks, in accordance with some embodiments of the present disclosure;

FIG. 2 illustrates a detailed diagram of a Centralized Unit (CU), in accordance with some embodiments of the present disclosure;

FIG. 3 illustrates an exemplary signaling diagram for performing TA acquisition procedure based on UE capability in wireless networks, in accordance with some embodiments of the present disclosure;

FIGS. 4 and 5 show exemplary flow charts illustrating method steps for performing TA acquisition procedure based on UE capability in wireless networks, in accordance with some embodiments of the present disclosure; and

FIG. 6 shows a diagram of example components of a CU for performing TA acquisition procedure based on UE capability in wireless networks, in accordance with embodiments of the present disclosure.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

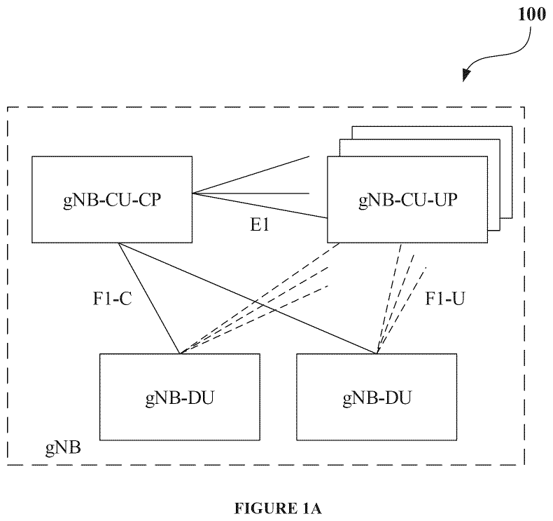

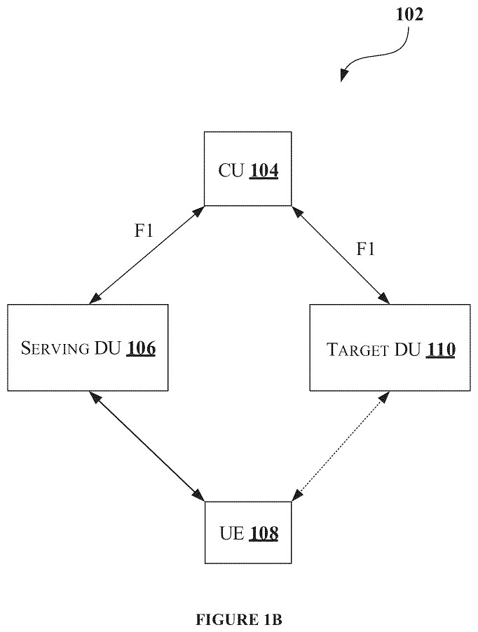

In 3GPP, a disaggregated architecture of gNodeB (gNB) is defined as decomposing the gNB into multiple logical entities, as shown in FIG. 1A. The gNB is split into three logical nodes i.e., Centralised Unit (CU) (also referred as gNB-CU), Distributed Unit (DU) (also referred as gNB-DU), and Radio Unit (RU) (not illustrated in Figures). In order to support L1/L2 centric inter-cell change (i.e. change of serving cell)/LTM in the disaggregated gNB architecture, a new mechanism is needed in which configuration takes place at the gNB-CU but is executed autonomously by the gNB-DU without further interaction with upper layers.

Release 18 specifies certain objectives for enhancing mobility. These objectives include:
To specify mechanism and procedures of L1/L2 based inter-cell mobility for mobility latency reduction:
   Configuration and maintenance for multiple candidate cells to allow fast application of configurations for candidate cells [RAN2, RAN3]
   Dynamic switch mechanism among candidate serving cells (including SpCell and SCell) for the potential applicable scenarios based on L1/L2 signalling [RAN2, RAN1]
   L1 enhancements for inter-cell beam management, including L1 measurement and reporting, and beam indication [RAN1, RAN2]
      Note 1: Early RAN2 involvement is necessary, including the possibility of further clarifying the interaction between this bullet with the previous bullet
   Timing Advance management [RAN1, RAN2]
   CU-DU interface signaling to support L1/L2 mobility, if needed [RAN3]

Note 2: FR2 specific enhancements are not precluded, if any.

Note 3: The procedure of L1/L2 based inter-cell mobility are applicable to the following scenarios:
Standalone, CA and NR-DC case with serving cell change within one CG
Intra-DU case and intra-CU inter-DU case (applicable for Standalone and CA: no new RAN interfaces are expected)
Both intra-frequency and inter-frequency
Both FR1 and FR2
Source and target cells may be synchronized or non-synchronized

The highlighted text (text indicated in bold) indicates that reduction of mobility latency and fast application of configuration for LTM are important objectives of Release 18.

Timing advance (TA) is used to control uplink transmission timing of individual UE. TA helps to ensure that uplink transmissions from all UE are synchronized. The UE needs to perform Timing advance (TA) acquisition to acquire the TA of a LTM candidate/target cell when there is a handover from a LTM serving cell to the LTM candidate/target cell. In traditional handover, the UE waits for Physical Random Access Channel (PRACH) occasion and performs RACH to synchronize with Plink (UL) of the LTM candidate/target cell. This is necessary as the TA of the LTM candidate/target cell (configured for handover) may be different from that of the LTM serving cell. During the RACH procedure, the UE acquires the TA of the LTM candidate/target cell.

For LTM, in order to reduce user-plane interruption time and latency during handover, the Third Generation Partnership Project (3GPP) specifies that the UE can be ordered by a serving gNB-DU associated with the LTM serving cell to perform UL sync operation with a target gNB-DU associated with the LTM candidate/target cell. The serving gNB-DU orders the UE using a PDCCH order, before LTM serving cell change. During the said UL sync operation, the UE sends already reserved Contention-Free Random Access (CFRA) preamble to the target gNB-DU and procures the TA of the LTM candidate/target cell. This is performed during LTM target candidate/cell preparation and relayed to the UE via the serving gNB-DU. The benefit of such a procedure is that the UE can avoid performing RACH during the actual LTM serving cell change, as the LTM candidate/target cell TA is already available and hence reduces handover latency.

In RAN1 #110, the following agreement was made which specifies the above-stated procedure:

On mechanism to acquire TA of the candidate cell(s) in Rel-18 LTM, at least support PDCCH ordered RACH.
The PDCCH order is only triggered by source cell
FFS: the details including content of DCI, RACH resource configuration, RAR transmission mechanism, etc.
For PDCCH ordered RACH in LTM, at least the following enhancements are supported
Introduce indication of candidate cell and/or RO of candidate cell in DCI
configuration of RACH resource for candidate cell(s) is provided prior to the PDCCH order
FFS: whether/how to transmit RAR

The above agreements made in RAN1/RAN2 substantiate the following:
Issuance of a PDCCH order from the serving gNB-DU to the UE to perform UL sync (RACH procedure to acquire TA from the LTM candidate/target cell) with the LTM candidate/target cell before a serving cell change, with the intent of acquiring UE's TA from the LTM candidate/target cell.
In Release 18, the UE's timing advance is sent from the target gNB-DU to the serving gNB-DU via a Centralized Unit (gNB-CU).
The serving gNB-DU delivers the TA to the UE in A LTM cell switch Media Access Control (MAC) Control Element (CE).

In RAN1 #113, the following agreement was made which provides an alternative method of acquiring the TA of the LTM candidate/target cell:
From RAN 1 perspective, UE-based TA measurement (UE derives TA based on Rx timing difference between current serving cell and candidate cell as well as TA value for the current serving cell) is supported.
   For a UE reports support of this capability, configuration of UE-based TA measurement is supported.

The said method has the following characteristics:
The said method is based on UE capability. This is configured by the gNB-CU using Radio Resource Control (RRC) messaging.
The said method does not require the UE to perform RACH towards the LTM candidate/target cell to acquire TA.

The said method does not require the target gNB-DU to reserve RACH resources for the UE to perform UL sync, during LTM candidate/target cell preparation.
The said method does not require the serving gNB-DU to provide TA while delivering the LTM cell switch command using a MAC CE.

However, whenever a capable UE is configured over RRC to perform UE-based TA measurement, the gNB-CU does not take any action towards the target gNB-DU and/or the serving gNB-DU. Hence, the target gNB-DU and/or the serving gNB-DU are not informed on the UE capability, and hence the RACH resources are still reserved for performing the UL sync operation to measure the TA. Thus, the network resources are wasted, and this causes sub-optimal network performance.

The present disclosure provides methods and apparatuses to perform TA acquisition procedure based on the UE capability in the wireless networks. In the present disclosure, a Centralized Unit (CU) (also referred as a gNB-CU) identifies a capability of a UE to perform TA measurement of LTM candidate cells, based on UE capability information received from the UE. The CU informs the UE capability information to a serving DU during configuration preparation of the LTM candidate cells in the UE. Also, the CU informs the UE capability information to a candidate/target DU associated with an LTM candidate/target cell. The serving DU and the candidate/target DU do not allocate Physical Random-Access Channel (PRACH) resources required for performing the UL synchronization to acquire TA, upon receiving the UE capability information from the CU. The CU receives acknowledgement from the serving DU and/or the candidate/target DU indicating non-allocation of the PRACH resources. Hence, the present disclosure avoids indefinite reservation, fragmentation, and wastage of network resources, when the UE is capable of TA measurement.

FIG. 1A illustrates a current disaggregated gNodeB (gNB) architecture. In Fifth Generation (5G) networks, a base station or a gNB is split into three distinct components i.e., a Centralized Unit (CU) (also referred as the gNB-CU in the description), a Distributed Unit (DU) (also referred as the gNB-DU in the description), and a Remote Radio Unit (RU) (not illustrated in figures). The gNB-CU serves as central intelligence, adeptly handling complex and centralized network functions. These functions include, but are not limited to, proficient radio resource management, effective network control, and seamless coordination with the 5GC. The gNB-DU is responsible for managing data plane processing, encompassing vital tasks such as data transmission and reception with a User Equipment (UE) (not illustrated in FIG. 1A). The gNB-DU interfaces seamlessly with the gNB-CU over F1 interface. FIG. 1A further illustrates a separation of control-plane and user-plane for the gNB-CU (i.e., gNB-CU-CP and gNB-CU-UP). The gNB-CU-CP is connected to the gNB-DU through F1-C interface. The gNB-CU-UP is connected to the gNB-DU through F1-U interface. The gNB-CU-CP is connected to gNB-CU-CP(s) over E1 interface. The RU deals with physical layer functions, housing antennas and radio transceivers that facilitate the actual transmission and reception of radio signals. The description of the present disclosure is explained considering Fifth Generation (5G) networks only. However, the present disclosure is applicable to any type of networks such as Fourth Generation (4G) networks, 6G networks, and the like.

FIG. 1B illustrates an exemplary environment 102 for performing TA acquisition procedure based on UE capability in wireless networks, in accordance with embodiments of the present disclosure. The exemplary environment 102 comprises a Centralized Unit (CU) 104, a serving Distributed Unit (DU) 106, a User Equipment (UE) 108, and a candidate/target DU 110. The CU 104 serves as central intelligence handling complex and centralized network functions. The CU 104 manages multiple DUs in the wireless networks. FIG. 1B illustrates only two DUs i.e., the serving DU 106 and the candidate/target DU 110 for explaining the present disclosure. However, the CUs can be associated with more than two DUs, and this should not be considered as limiting. Similarly, the wireless network may include more than one CU, and thus should not be considered as limiting. The serving DU 106 is associated with a LTM serving cell camped on by the UE 108, and is responsible for managing data plane processing, data transmission and reception with the UE 108.

The UE 108 represents end-user devices that access services and applications through a wireless network. The UE 108 is configured to connect to the CU 104 and DUs over the wireless network. Examples of the UE 108 include, but not limited to, any device used by a user to communicate over the wireless network, such as, but not limited to, mobile phones, smartphones, laptops, wearables, Internet of Things (IoTs), and the like. The UE 108 communicates to the CU 104 via the serving DU 106, over F1 interface. The UE 108 may be configured with Lower-layer Triggered mobility (LTM) or L1/L2 based mobility with the serving DU 106. LTM is a procedure in which a gNB receives L1 measurement reports from UEs, and on their basis the gNB changes serving cell of the UEs through a Media Access Control (MAC) Control Element (CE). The UE 108 may switch from the LTM serving cell to a LTM candidate/target cell associated with the candidate/target DU 110. The serving DU 106 and the candidate/target DU 110 interfaces with the CU 104 over F1 interface.

Timing advance (TA) is used to control uplink transmission timing of the UE 108. TA helps to ensure that uplink transmissions from all UE are synchronized. The UE needs to perform TA acquisition to acquire the TA of a LTM candidate/target cell when there is a handover from the LTM serving cell to the LTM candidate/target cell. In the present disclosure, the CU 104 is configured to perform TA acquisition procedure based on capability of the UE 108, such that network resources are not wasted. Herein, the CU 104 is configured to identify a capability of the UE 108 to perform TA measurement of LTM candidate cells, based on UE capability information received from the UE 108. The CU 104 transmits the UE capability information to the serving DU 106, during configuration preparation of the LTM in the UE. Also, the CU 104 transmits the UE capability information to the candidate/target DU 110 associated with an LTM candidate/target cell selected from the LTM candidate cells. In the present description, an LTM candidate/target cell refers an LTM candidate cell which is selected for LTM handover. The serving DU 106 and the candidate/target DU 110 do not allocate Physical Random-Access Channel (PRACH) resources to perform the UL synchronization to acquire TA of the LTM candidate/target cell, upon receiving the UE capability information from the CU 104. The CU 104 receives an acknowledgement from the serving DU 106 and/or the candidate/target DU (110) that PRACH resources to perform the UL synchronization are not allocated. In this way, the PRACH resources are not allocated, when the UE 108 has the capability to perform the TA measurement.

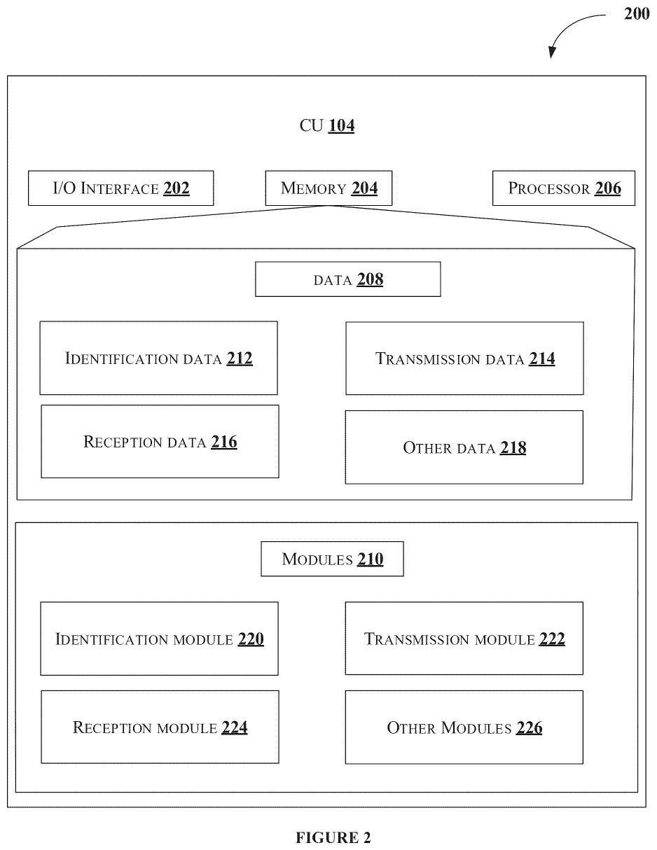

FIG. 2 illustrates a detailed diagram of the CU 104, in accordance with some embodiments of the present disclosure. The CU 104 may include Input/Output (I/O) interface 202, a memory 204, and a Central Processing Unit (also referred as “CPU” or “a processor 206”). In some embodiments, the memory 204 may be communicatively coupled to the processor 206. The memory 204 stores instructions executable by the processor 206. The processor 206 may comprise at least one data processor for executing program components for executing user or system-generated requests. The memory 204 may be communicatively coupled to the processor 206. The memory 204 stores instructions, executable by the processor 206, which, on execution, may cause the processor 206 to perform the TA acquisition procedure. The I/O interface 202 is coupled with the processor 206 through which an input signal or/and an output signal is communicated. For example, the CU 104 transmits the UE capability information to the serving DU 106 and the candidate/target DU 110, via the I/O interface 202. Also, the CU 104 receives the acknowledgement from the serving DU 106 and/or the candidate/target DU 110, via the I/O interface 202. In an embodiment, the CU 104 may be implemented in a variety of computing systems, such as a server, a network server, a cloud-based server, and the like.

In an embodiment, the memory 204 may include one or more modules 210 and data 208. The one or more modules 210 may be configured to perform the steps of the present disclosure using the data 208. In an embodiment, each of the one or more modules 210 may be a hardware unit which may be outside the memory 204 and coupled with the CU 104. As used herein, the term modules 210 refer to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. The one or more modules 210 when configured with the described functionality defined in the present disclosure will result in a novel hardware.

In one implementation, the modules 210 may include, for example, an identification module 220, a transmission module 222, a reception module 224, and other modules 226. It will be appreciated that such aforementioned modules may be represented as a single module or a combination of different modules. In one implementation, the data 208 may include, for example, identification data 212, transmission data 214, reception data 216, and other data 218.

In an embodiment, the identification module 220 is configured to identify a capability of the UE 108 to perform TA measurement of LTM candidate cells. The identification module 220 identifies the capability to perform the TA measurement based on the UE capability information received from the UE 108. The UE capability information is a message that the UE transmits to a network (CU 104 in this case). The UE network capability refers to the set of capabilities and features that a UE possesses and can support when interacting with the network. The UE capability information is transmitted during initial registration process in most of the cases. The UE 108 informs details of all its capabilities to the CU 104 in the UE capability information. In an embodiment, the UE capability information is received in a RRC message during RRC setup procedure or subsequently. For example, the UE 108 may inform all its capabilities such as TA measurement, supported band in single carrier, supported Carrier Aggregation (CA), supported Universal Mobile Telecommunications Service (UMTS), and the like, in the RRC message during the RRC setup procedure.

In another example, the CU 104 may receive the UE capability information from the UE 108 subsequently. For instance, the CU 104 may transmit a message “UECapabilityEnquiry” to the UE 108 subsequently during an active session of the UE 108. The UE 108 may report the UE capability information in a message “UECapabilityInformation” to the CU 104. A person skilled in the art will appreciate that the UE capability information may be received at the CU 104 using any other known methods/procedures, and the above-stated methods should not be considered as limiting.

The identification module 220 may identify that the UE 108 is capable of performing TA measurement based on a support for “UE-based TA measurement” in the UE capability information. The capability “UE-based TA measurement” indicates that a UE can derive the TA based on receiver (Rx) timing difference between a current serving cell and a candidate cell as well as TA value for the current serving cell. The LTM candidate cell is a LTM cell which is selected as a candidate for LTM handover. The LTM candidate cell is termed as a LTM target cell when such a cell is selected for the LTM handover. Hence, the phrase “perform TA measurement of LTM candidate cells” refers to “perform TA measurement of LTM candidate/target cell”. The CU 104 configures the UE 108 to perform TA measurement of the LTM candidate cells, on receiving the UE capability information.

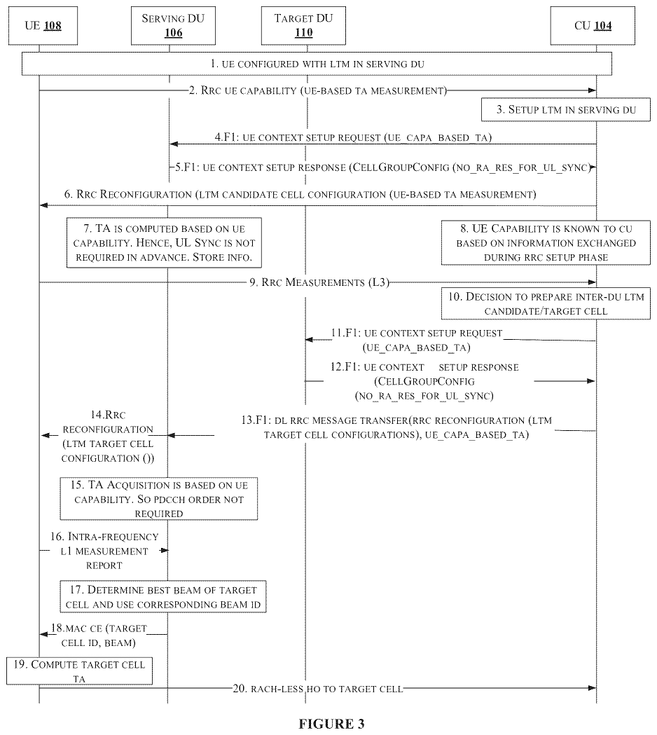

Referring to a signaling diagram illustrated in FIG. 3, the UE 108 is configured with LTM in the serving DU 106, as shown in step 1. The CU 104 receives the UE capability information indicating “UE-based TA measurement” in an RRC message during RRC setup phase, at step 2. The CU 104 identifies a capability of the UE 108 to perform the TA measurement based on the UE capability information. The CU 104 performs LTM setup in the serving DU 106, at step 3. Referring back to FIG. 2, the UE capability information may be stored as the identification data 212 in the memory 204.

In an embodiment, the transmission module 222 may be configured to receive the identification data 212 from the identification module 220. Further, the transmission module 222 may be configured to transmit the UE capability information to the serving DU 106. The transmission module 222 transmits the UE capability information during configuration preparation of the LTM in the UE. The configuration of the LTM candidate cells is transmitted from the CU 104 to the UE 108, via the serving DU 106. While sending the configuration of the LTM candidate cells to the UE 108, via the serving DU 106, the CU 104 indicates to the serving DU 106 in a parameter that the UE 108 has been configured with “UE-based TA measurement” and has capability to acquire TA of the LTM candidate cell on its own. The UE capability information is transmitted to the serving DU 106 so that the serving DU 106 does not allocate the PRACH resources for performing UL synchronization to acquire the TA of the LTM candidate cells. The serving DU 106 only provides a cell Identification (ID) of the LTM candidate cell to the UE 108 whenever the TA of the LTM candidate cell needs to be acquired.

Referring again to FIG. 3, the transmission module 222 is configured to transmit the UE capability information to the serving DU 106, during configuration preparation of the LTM in the UE 108, as shown in step 4. At step 6, the CU 104 performs the configuration of the LTM candidate cells in the UE 108. As shown in step 7, the serving DU 106 may store information regarding UE-based TA measurement. As shown in step 18, the serving DU 106 does not send the TA, but only sends the cell ID of the LTM candidate cell to the UE 108 when the TA of the LTM candidate cell needs to be acquired.

Referring back to FIG. 2, the transmission module 222 is configured to transmit the UE capability information to the candidate/target DU 110 associated with an LTM candidate/target cell selected from the LTM candidate cells. In an embodiment, the transmission module 222 transmits the UE capability information to the candidate/target DU 110 during preparation of the LTM candidate/target cell. At the time of preparing the LTM candidate/target cell, the transmission module 222 indicates using a parameter to the candidate/target DU 110 that the UE is configured with the capability “UE-based TA measurement” in the UE capability information. The transmission module 222 indicates the UE capability information so that the candidate/target DU 110 does not reserve or allocate PRACH resources for acquiring TA of the LTM candidate/target cell. The candidate/target DU 110 does not allocate any PRACH resources in candidate cell configuration (CellGroupConfig parameter) for acquiring the TA of the LTM candidate/target cell.

Referring again to FIG. 3, the CU 104 is aware of the UE capability based on the UE capability information received from the UE 108. The CU 104 performs the cell preparation based on L3 measurements received from the UE 108, as shown in steps 9 and 10. During the preparation, the transmission module 222 transmits the UE capability information to the candidate/target DU 110, as shown in step 11. Referring back to FIG. 2, information related to transmission of the UE capability information to the serving DU 106 and the candidate/target DU 110 may be stored as the transmission data 214 in the memory 204.

In an embodiment, the reception module 224 is configured to receive an acknowledgement from the serving DU 106 and/or the candidate/target DU 110. The acknowledgment indicates a response from the serving DU 106 and/or the candidate/target DU 110 indicating non-allocation of the PRACH resources to the UE 108. Generally, the PRACH resources are allocated by the serving DU 106 and the candidate/target DU 110 so that the UE 108 can perform UL synchronization in a PRACH occasion with the candidate/target DU 110 via the serving DU 106. The TA of the LTM candidate/target cell is communicated to the UE 108 prior to the serving cell change, upon performing of the UL synchronization. As the UE 108 has the capability to perform the TA measurement, the UE 108 can compute the TA on its own. Hence, there is no requirement to perform the UL synchronization, and no PRACH resources need to be allocated to the UE 108. The acknowledgements received from the serving DU 106 and/or the candidate/target DU 110 may be stored as the reception data 216 in the memory 204.

Referring again to FIG. 3, the reception module 224 is configured to receive the acknowledgement from the serving DU 106 and/or the candidate/target DU 110, at steps 5 and 12, respectively. The configuration of the LTM candidate/target cell and the handover to the LTM candidate/target cell is performed as shown in steps 13-20. As shown, the UE 108 computes the TA of the LTM candidate/target cell at step 19, upon receiving the cell ID of the LTM candidate/target cell from the serving DU 106. Hence, the present disclosure enables non-allocation of PRACH resources to acquire TA, when the UE 108 has capability to perform the TA measurement.

The other data 218 may store data, including temporary data and temporary files, generated by the one or more modules 210 for performing the various functions of the CU 104. The other data 218 may be stored in the memory 204. The one or more modules 210 may also include the other modules 226 to perform various miscellaneous functionalities of the CU 104.

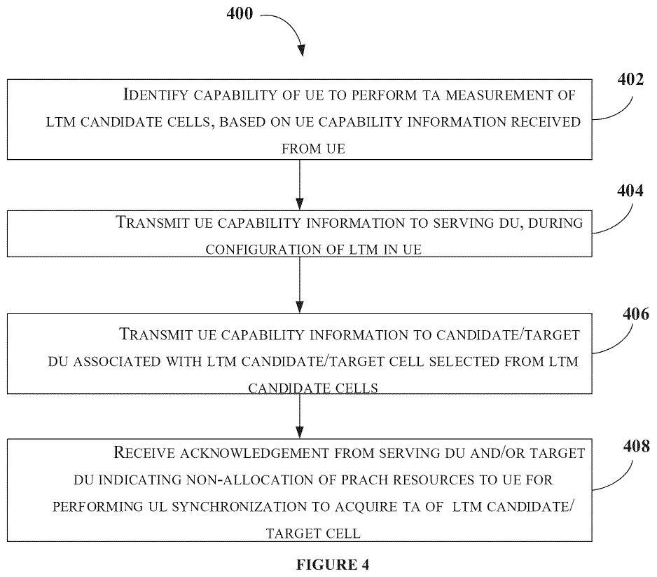

FIG. 4 shows an exemplary flow chart illustrating method steps for performing TA acquisition procedure, in accordance with some embodiments of the present disclosure. As illustrated in FIG. 4, the method 400 may comprise one or more steps. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 402, a capability of the UE 108 to perform TA measurement of LTM candidate cells is identified. The CU 104 identifies the capability to perform the TA measurement based on the UE capability information received from the UE 108. The UE network capability refers to the set of capabilities and features that a UE possesses and can support when interacting with the network. In an embodiment, the UE capability information is received in a RRC message during RRC setup procedure or subsequently. The CU 104 may identify that the UE 108 is capable of performing TA measurement based on a support for “UE-based TA measurement” in the UE capability information. The capability “UE-based TA measurement” indicates that a UE can derive the TA based on receiver (Rx) timing difference between a current serving cell and a candidate cell as well as TA value for the current serving cell.

At step 404, the UE capability information is transmitted to the serving DU 106. The CU 104 transmits the UE capability information during configuration preparation of the LTM in the UE. The configuration of the LTM candidate cells is transmitted from the CU 104 to the UE 108, via the serving DU 106. While sending the configuration of the LTM candidate cells to the UE 108, via the serving DU 106, the CU 104 indicates to the serving DU 106 in a parameter that the UE 108 has been configured with “UE-based TA measurement”.

At step 406, the UE capability information is transmitted to the candidate/target DU 110 associated with an LTM candidate/target cell selected from the LTM candidate cells. In an embodiment, the CU 104 transmits the UE capability information to the candidate/target DU 110 during preparation of the LTM candidate/target cell. At the time of preparing the LTM candidate/target cell, the CU 104 indicates using a parameter to the candidate/target DU 110 that the UE is configured with the capability “UE-based TA measurement” in the UE capability information.

At step 408, an acknowledgement is received from the serving DU 106 and/or the candidate/target DU 110. The acknowledgment indicates a response from the serving DU 106 and the candidate/target DU 110 indicating non-allocation of the PRACH resources to the UE 108.

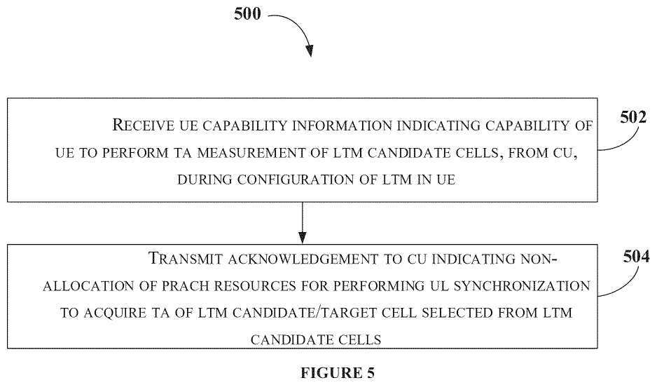

FIG. 5 shows an exemplary flow chart illustrating method steps for performing TA acquisition procedure, in accordance with some embodiments of the present disclosure. As illustrated in FIG. 5, the method 500 may comprise one or more steps. The method 500 may be described in the general context of computer executable instructions. Generally, computer executable instructions can include routines, programs, objects, components, data structures, procedures, modules, and functions, which perform particular functions or implement particular abstract data types.

The order in which the method 500 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 502, UE capability information indicating a capability of a UE 108 to perform TA measurement of the LTM candidate cells is received from the CU 104. The serving DU 106 receives the UE capability information from the CU 104 during configuration preparation of the LTM in the UE 108. The configuration of the LTM candidate cells is transmitted from the CU 104 to the UE 108, via the serving DU 106. While sending the configuration of the LTM candidate cells to the UE 108, via the serving DU 106, the CU 104 indicates to the serving DU 106 in a parameter that the UE 108 has been configured with “UE-based TA measurement” and has capability to acquire TA of the LTM candidate cell on its own. The serving DU 106 does not allocate the PRACH resources for performing UL synchronization to acquire the TA of the LTM candidate cells.

At step 504, an acknowledgement is transmitted to the CU 104 indicating non-allocation of the PRACH resources for performing UL synchronization to acquire TA of an LTM candidate/target cell selected from the LTM candidate cells. Referring again to FIG. 3, the serving DU 106 transmits the acknowledgment to the CU 104 at step 5. As shown in step 14, the serving DU 106 transmits the configuration of the LTM candidate cells which is received from the CU 104. In an embodiment, the serving DU 106 transmits the cell ID of the LTM candidate/target cell in a Physical Downlink Control Channel (PDCCH) order to the UE 108 to determine the TA of the LTM candidate/target cell. The PDCCH order may be transmitted prior to the LTM cell switch when that the serving DU 106 needs to verify the accuracy of the TA computed by the UE 108. In such a case, the serving DU 106 may also configure the UE 108 to report back the TA computed by the UE 108 and verify the accuracy. In another embodiment, the PDCCH order can be avoided, and the serving DU 106 provides the cell ID of the LTM candidate/target cell in an LTM cell switch command (for instance, MAC CE) to the UE 108, as shown in steps 15-18. Hence there is no need to provide TA value in the cell switch command to the UE 108. The serving DU 106 just provides the cell ID of the LTM candidate/target cell in the LTM cell switch command.

In an embodiment, the serving DU 106 may comprise a processor, a memory, and an I/O interface (not illustrated in Figures). In some embodiments, the memory stores instructions executable by the processor, which, on execution, may cause the processor to perform the TA acquisition procedure. In an embodiment, the memory may include one or more modules and associated data. The one or more modules may be configured to perform the steps 502 and 504 of the present disclosure.

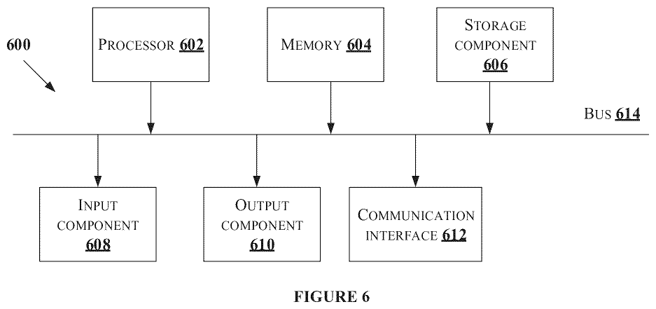

FIG. 6 illustrates an embodiment of a CU 600. As shown in FIG. 6, the CU 600 comprises a processor 602, a memory 604, a storage component 606, an input component 608, an output component 610, a communication interface 612, and a bus 614. The CU 600 may be used to realize the CU 104 of FIG. 2. Hence, the CU 600 may be used to perform the TA acquisition procedure based on the UE capability in the wireless networks, in accordance with embodiments of the present disclosure.

The processor 602, as used herein, means any type of computational circuit that may comprise hardware elements and software elements. The processor 602 may be embodied as a multi-core processor, a single core processor, or a combination of one or more multi-core processors and/or one or more single core processors, a distributed processing system, or the like. The processor 602 may be a Central Processing Unit (CPU), a graphics processing unit (GPU), an accelerated processing unit (APU), an application-specific integrated circuit (ASIC), or another type of processing component. The processor 602 may be used to realize the processor 206 described in FIG. 2.

The memory 604 includes a non-transitory computer readable medium. Memory 604 includes a random-access memory (RAM), a read only memory (ROM), and/or another type of dynamic or static storage device (e.g., a flash memory, a magnetic memory, and/or an optical memory) that stores information and/or instructions for use by processor 602. The memory 604 comprises machine-readable instructions which are executable by the processor 602. These machine-readable instructions when executed by the processor 602 cause the processor 602 to perform one or more method steps of an embodiment described above. The memory 604 may be used to realize the memory 204 described in FIG. 2. The memory 604 is communicatively coupled to the processor 602. The memory 604 stores instructions, executable by the one or more processors 602, which, on execution, may cause the processor 602 to perform the TA acquisition procedure based on the UE capability in the wireless networks, in accordance with embodiments of the present disclosure.

The storage component 606 stores information and/or software related to the operation and use of the CU 600. For example, the storage component 606 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The input component 608 is configured to receive information, such as user input. For example, the input component 608 may include, but not be limited to, a touch screen display, a keyboard, a keypad, a mouse, a button, a switch, and/or a microphone. Additionally, or alternatively, the input component 608 may include a sensor for sensing information (e.g., a global positioning system (GPS), an accelerometer, a gyroscope, and/or an actuator).

The output component 610 is configured to provide output information from the CU 600. For example, the output component 610 may be, but not limited to, a display, a speaker, instructions to an external device, and/or one or more light-emitting diodes (LEDs).

The communication interface 612 is an interface that provides a communication connection to other devices, such as external devices and internal devices. The connection by the communication interface 612 can be a wired connection, a wireless connection, or a combination of wired and wireless connections, and can be a direct connection or an indirect connection via a communication network that exists between the CU 600 and other devices. In other words, the standard of the communication interface 612 is not limited. The CU 600 may communicate with the serving DU 106, the candidate/target DU 110, and the UE 108, over a communication network 609.

The bus 614 acts as an interconnect between the processor 602, the memory 604, the storage component 606, the input component 608, the output component 610, and the communication interface 612 of the CU 600. The bus 614 may include a wired interconnection or a wireless interconnection.

The number and arrangement of components shown in FIG. 6 are provided as an example. In practice, the CU 600 may include additional components, fewer components, different components, or differently arranged components than those shown in FIG. 6. Additionally, or alternatively, a set of components (e.g., one or more components) of the CU 600 may perform one or more functions described as being performed by another set of components of the CU 600.

In an embodiment [1], the present disclosure discloses a method comprising identifying a capability of a UE 108 to perform TA measurement of LTM candidate cells, based on UE capability information received from the UE 108. Further, the method comprises transmitting the UE capability information to a serving DU 106, during configuration preparation of the LTM in the UE. The method comprises transmitting the UE capability information to a candidate/target DU 110 associated with an LTM candidate/target cell selected from the LTM candidate cells. Thereafter, the method comprises receiving an acknowledgement from the serving DU 106 and/or the candidate/target DU 110 indicating non-allocation of PRACH resources to the UE 108 for performing UL synchronization to acquire TA of the LTM candidate/target cell.

In an embodiment [2], the method, described in the embodiment [1], the UE capability information is received in a Radio Resource Control (RRC) message during RRC setup procedure or subsequently.

In an embodiment [3], the method, described in the embodiments [1] or [2], the UE capability information is transmitted to the candidate/target DU 110 during preparation of the LTM candidate/target cell.

In an embodiment [4], the method, described in the embodiments [1] or [2], comprises configuring the UE 108 to perform TA measurement of the LTM candidate cells, on receiving the UE capability information.

In an embodiment [5], the present disclosure discloses a method comprising receiving UE capability information indicating a capability of the UE 108 to perform TA measurement of LTM candidate cells, from a CU 104, during configuration preparation of LTM in the UE 108. Further, the method comprises transmitting an acknowledgement to the CU 104 indicating non-allocation of PRACH resources for performing UL synchronization to acquire TA of an LTM candidate/target cell selected from the LTM candidate cells.

In an embodiment [6], the method, described in the embodiment [5], the method further comprises transmitting a cell ID of the LTM candidate/target cell to the UE 108 to determine the TA of the LTM candidate/target cell.

In an embodiment [7], the method, described in the embodiments [5] or [6], the cell ID of the LTM candidate/target cell is transmitted in a PDCCH order to the UE 108.

In an embodiment [8], the method, described in the embodiments [5] or [6], the cell ID of the LTM candidate/target cell is transmitted in an LTM cell switch command to the UE 108.

In an embodiment [9], the method, described in the embodiments [5] or [6], the UE 108 determines the TA of the LTM candidate/target cell based on receiver (Rx) timing difference between a current serving cell of the UE 108 and the LTM candidate/target cell, and TA of the current serving cell.

In an embodiment [10], the present disclosure discloses a CU 104 configured to identify a capability of a UE 108 to perform TA measurement of LTM candidate cells, based on UE capability information received from the UE 108. Further, the CU 104 is configured to transmit the UE capability information to a serving DU 106, during configuration preparation of the LTM in the UE 108. Furthermore, the CU 104 is configured to transmit the UE capability information to a candidate/target DU 110 associated with an LTM candidate/target cell selected from the LTM candidate cells. Thereafter, the CU 104 is configured to receive an acknowledgement from the serving DU 106 and/or the candidate/target DU 110 indicating non-allocation of PRACH resources to the UE 108 for performing UL synchronization to acquire TA of the LTM candidate/target cell.

In an embodiment [11], the CU 104, described in the embodiment [10], receives the UE capability information in a RRC message during RRC setup procedure or subsequently.

In an embodiment [12], the CU 104, described in the embodiment [10], transmits the UE capability information to the candidate/target DU 110 during preparation of the LTM candidate/target cell.

In an embodiment [13], the CU 104, described in the embodiments [10] or [11], configures the UE 108 to perform TA measurement of the LTM candidate cells, on receiving the UE capability information.

In an embodiment [14], the present disclosure discloses a serving DU 106 configured to receive UE capability information indicating a capability of a UE 108 to perform TA measurement of LTM candidate cells, from a CU 104, during configuration preparation of the LTM in the UE 108. Further, the serving DU 106 is configured to transmit an acknowledgement to the CU 104 indicating non-allocation of PRACH resources for performing UL synchronization to acquire TA of an LTM candidate/target cell selected from the LTM candidate cells.

In an embodiment [15], the serving DU 106, described in the embodiment [14], further configured to transmit a cell ID of the LTM candidate/target cell to the UE 108 to determine the TA of the LTM candidate/target cell.

In an embodiment [16], the serving DU 106, described in the embodiments [14] or [15], configured to transmit the cell ID of the LTM candidate/target cell in a PDCCH order to the UE 108.

In an embodiment [17], the serving DU 106, described in the embodiments [14] or [15], configured to transmit the cell ID of the LTM candidate/target cell in an LTM cell switch command to the UE 108.

In an embodiment [16], the present disclosure discloses a non-transitory computer readable medium including instructions for performing operations comprising identifying a capability of a UE 108 to perform TA measurement of LTM candidate cells, based on UE capability information received from the UE 108. Further, the operations comprise transmitting the UE capability information to a serving DU 106, during configuration preparation of the LTM in the UE 108. Furthermore, the operations comprise transmitting the UE capability information to a candidate/target DU 110 associated with an LTM candidate/target cell selected from the LTM candidate cells. Thereafter, the operations comprise receiving an acknowledgement from the serving DU 106 and/or the candidate/target DU 110 indicating non-allocation of PRACH resources to the UE 108 for performing UL synchronization to acquire TA of the LTM candidate/target cell.

1. A method comprising:
identifying, by a Centralized Unit (CU), a capability of a UE to perform Timing Advance (TA) measurement of Layer1/layer2 Triggered Mobility (LTM) candidate cells, based on UE capability information received from the UE;
transmitting, by the CU, the UE capability information to a serving Distributed Unit (DU), during configuration preparation of the LTM in the UE;
transmitting, by the CU, the UE capability information to a candidate/target DU associated with an LTM candidate/target cell selected from the LTM candidate cells; and
receiving, by the CU, an acknowledgement from the serving DU and/or the candidate/target DU indicating non-allocation of Physical Random-Access Channel (PRACH) resources to the UE for performing Uplink (UL) synchronization to acquire TA of the LTM candidate/target cell.

2. The method as claimed in claim 1, wherein the UE capability information is received from the UE in a Radio Resource Control (RRC) message during RRC setup procedure or subsequently.

3. The method as claimed in claim 1, wherein the UE capability information is transmitted to the candidate/target DU during preparation of the LTM candidate/target cell.

4. The method as claimed in claim 1, comprising:
configuring the UE to perform UE capability based TA measurement of the LTM candidate cells, on receiving the UE capability information.

5. A method comprising:
receiving, by a serving Distributed Unit (DU), User Equipment (UE) capability information indicating a capability of a UE to perform Timing Advance (TA) measurement of LTM candidate cells, from a Centralized Unit (CU), during configuration preparation of the LTM in the UE; and
transmitting, by the serving DU, an acknowledgement to the CU indicating non-allocation of Physical Random-Access Channel (PRACH) resources for performing Uplink (UL) synchronization to acquire TA of an LTM candidate/target cell selected from the LTM candidate cells.

6. The method as claimed in claim 5, further comprising:
transmitting a cell Identification (ID) of the LTM candidate/target cell to the UE to determine the TA of the LTM candidate/target cell.

7. The method as claimed in claim 6, wherein the cell ID of the LTM candidate/target cell is transmitted in a Physical Downlink Control Channel (PDCCH) order to the UE to compute the TA of the candidate/target cell.

8. The method as claimed in claim 6, wherein the cell ID of the LTM candidate/target cell is transmitted in an LTM cell switch command to the UE to compute the TA of the candidate/target cell.

9. The method as claimed in claim 6, wherein the UE determines the TA of the LTM candidate/target cell based on receiver (Rx) timing difference between a current serving cell of the UE and the LTM candidate/target cell, and TA of the current serving cell.

10. A Centralized Unit (CU) configured to:
identify a capability of a UE to perform Timing Advance (TA) measurement of Layer1/layer2 Triggered Mobility (LTM) candidate cells, based on UE capability information received from the UE;
transmit the UE capability information to a serving Distributed Unit (DU), during configuration preparation of the LTM in the UE;
transmit the UE capability information to a candidate/target DU associated with an LTM candidate/target cell selected from the LTM candidate cells; and
receive an acknowledgement from the serving DU and/or the candidate/target DU indicating non-allocation of Physical Random-Access Channel (PRACH) resources to the UE for performing Uplink (UL) synchronization to acquire TA of the LTM candidate/target cell.

11. The CU as claimed in claim 10, wherein the CU receives the UE capability information from the UE in a Radio Resource Control (RRC) message during RRC setup procedure or subsequently.

12. The CU as claimed in claim 10, wherein the CU transmits the UE capability information to the candidate/target DU during preparation of the LTM candidate/target cell.

13. The CU as claimed in claim 10, configures the UE to perform UE capability based TA measurement of the LTM candidate cells, on receiving the UE capability information.

14. (canceled)

15. (canceled)

16. (canceled)

17. (canceled)

18. A non-transitory computer readable medium including instructions for performing operations comprising:
identifying a capability of a UE to perform Timing Advance (TA) measurement of Layer1/layer2 Triggered Mobility (LTM) candidate cells, based on UE capability information received from the UE;
transmitting the UE capability information to a serving Distributed Unit (DU), during configuration preparation of the LTM in the UE;
transmitting the UE capability information to a candidate/target DU associated with an LTM candidate/target cell selected from the LTM candidate cells; and
receiving an acknowledgement from the serving DU and/or the candidate/target DU indicating non-allocation of Physical Random-Access Channel (PRACH) resources to the UE for performing Uplink (UL) synchronization to acquire TA of the LTM candidate/target cell.
